(19) United States
(12) Patent Application Publication
(10) Pub. No.: US 2023/0337701 A1
(43) Pub. Date: Oct. 26, 2023

(54) METHOD OF PRODUCING ANIMAL FEED FOR IMPROVED PROTEIN UTILIZATION

(71) Applicant: Boveta Nutrition LLC, Atlanta, GA (US)

(72) Inventors: Michael J. Cecava, Monticello, IL (US); James L. Dunn, Mendon, IL (US)

(73) Assignee: Boveta Nutrition LLC, Atlanta, GA (US)

(21) Appl. No.: 18/303,330

(22) Filed: Apr. 19, 2023

Related U.S. Application Data
(63) Continuation of application No. PCT/US2021/056226, filed on Oct. 22, 2021.
(60) Provisional application No. 63/105,096, filed on Oct. 23, 2020.

(51) Int. Cl. A23K 50/10; A23K 20/147; A23K 40/00; A23K 10/30; A23K 10/16; A23K 20/163; A23K 10/14; A23K 20/20; A23K 10/33; A23K 20/24; A23K 10/38

(52) U.S. Cl. CPC A23K 50/10; A23K 20/147; A23K 40/00; A23K 10/30; A23K 10/16; A23K 20/163; A23K 10/14; A23K 20/30; A23K 10/33; A23K 20/24; A23K 10/38

(57) ABSTRACT

The present application discloses embodiments of a method for producing a feed. The method may comprise mixing selected protein sources to produce a protein mixture having an amino acid pattern that aligns with ruminant lean tissue, milk protein, or both; adding processing aids to the protein mixture to facilitate non-enzymatic browning of proteins provided by the protein sources; adding a solvent to the protein mixture to form a solvent mixture; optionally agitating and/or heating the solvent protein mixture; drying the solvent protein mixture to form a dried protein mixture; and processing the dried protein mixture to produce a final dry mixture having a particle size of from 800 to 1200 microns. Disclosed embodiments also concern products made by the method, and administering the products to an animal, particularly a ruminant.

### CROSS REFERENCE TO RELATED APPLICATIONS

This application is a continuation of International Application No. PCT/US2021/056226, filed Oct. 22, 2021, which was published in English under PCT Article 21(2), which in turn claims the benefit of U.S. Provisional Application No. 63/105,096, filed Oct. 23, 2020, each of which is incorporated herein in its entirety.

### FIELD

A method for improving efficiency of protein utilization by animals, particularly ruminants, is disclosed, and certain embodiments concern a method for manufacturing a ruminant feed that, when consumed by the ruminant, provides a greater amount and improved index of amino acids for absorption and utilization by the animal.

### BACKGROUND

It has been recognized for some that the proteins fed to ruminants are subject to digestion in the rumen thereby diminishing their feeding value. Ideally the protein components of the ruminant feed should be protected against being solubilized and subjected to proteolytic enzymes of the rumen micro-organisms, thus enabling the proteins to pass from the rumen system substantially undegraded, while remaining digestible and metabolizable in the post-rumen digestive. The development of practical methods for improving the passage of proteins from the rumen as described by the prior art relies on mechanical, thermal, and chemical processing alone or in combinations and is applied primarily to individual ingredients to alter the physical characteristics of the ingredients. Altering physical characteristic particularly protects proteinaceous feeds from microbial attack in the rumen and permits digestion of more of the feed within the abomasum and small intestine. Various feed materials may be treated by one or more of these procedures, and the prior art discloses processing vegetable meals, particularly oilseed meals such as soybean meal. It is particularly desirable to provide a commercially practical method for protecting proteins that provides essential amino acids in amounts that reflect the requirements for amino acids in lean tissue and milk protein. In so delivering an ‘ideal’ protected protein, the efficiency of protein utilization for weight gain or milk production may be improved. The problem is that the protein in feed materials is inherently imbalanced relative to the composition of lean tissue or milk protein and for the most part, the proteins are susceptible to degradation in the rumen.

The development of a practical method for protecting proteins from rumen degradation has been pursued over several decades, but has met varying degrees of success. However, previous efforts have not disclosed optimizing feeds.

U.S. Pat. No. 4,172,072 describes an invention whereby protein sources are subjected to hydrolysis by the action of specific proteases under neutral conditions and are then reacted with water soluble bivalent metal salts in an aqueous alkaline media to form metal proteinates which are then buffered thereby forming biologically acceptable metal proteinates which are protected from adverse acid or alkaline destruction.

U.S. Pat. No. 4,664,905 is concerned with improvement in the nutritive value of soybean meal and other oil seed proteinaceous meals for feeding cattle. The improvement is accomplished by treating the meals with a water-soluble zinc salt to provide zinc ions for reaction with the protein. The treatment reduces the rumen digestibility of the protein of the meal and thereby improves its nutritive value. The '905 patent was licensed to Central Soya and is used in the manufacture of ProTek.

U.S. Pat. No. 5,225,230 discloses preparation of a bypass soybean product using partial de-oiling and mechanical processing of the soybeans at elevated temperature. The '230 patent discloses a bypass value of 55-65% and delivery of at least 8 grams of lysine and methionine per pound of ingested feed. The patent is assigned to West Central Coop and is used in the manufacture of SoyPlus.

U.S. Pat. No. 5,789,001 discloses a ruminally inert fat for a ruminant feed that is made by applying reducing sugars to oilseed meats and heating to induce non-enzymatic browning. The process is controlled to ensure penetration of the reducing sugars into the interior of cracked oilseed meat prior to browning. The browning reaction renders the protein which surrounds the oil resistant to rumen bacterial degradation to thereby encapsulate the oil in a protective matrix.

U.S. Pat. No. 5,824,355 encompasses protein-protected ruminant feed comprising oil seed meal, hulls, and water that has been cooked to give a cooked meal having a temperature of at least 200° F. and a moisture content of from 21 to 26 wt % and thereafter drying and cooling the moist cooked feed to give a protein protected ruminant feed. The protein protected ruminant feed is less digestible in the rumen and thereby enhances ruminant growth and milk production. The patent is assigned to AGP and the associated commercial product is AminoPlus.

U.S. Pat. No. 6,506,423 describes preparing a feedstuff with reduced ruminal protein degradability by mixing a carbohydrase enzyme with a material suitable for livestock feed and steeping the mixture under suitable conditions for the carbohydrase enzyme to hydrolyze carbohydrates contained within the material to reducing forms. The mixture is then heated to induce browning so that the protein contained within the material is rendered inert to ruminal degradation. The carbohydrase enzyme may be supplied to the steeping step by the addition of a microorganism capable of secreting the enzyme. A method of feeding a feedstuff with reduced ruminal degradability is also provided. The '423 patent is assigned to Kansas St. University and licensed to Afrigri-Tech and ostensibly practiced in the manufacture of AminoMax.

U.S. Pat. No. 7,297,356 An animal feed that comprises a feedstuff and a coating, where the coating increases the amount of the feedstuff that passes through the rumen without being degraded by the rumen microflora, thereby delivering a larger portion of that feedstuffs associated preformed protein, and the essential amino acids comprising that protein, to the lower gastrointestinal tract. A process for making an animal feed, where the animal feed has enhanced rumen bypass nature of feed ingredients and their associated nutrients, particularly preformed protein and the amino acids that comprise the protein. Methods of increasing the rumen bypass of phosphatidylcholine, methods of increasing the vitamin E value of a feedstuff, methods for increasing rumen escape of the protein and amino acids in a ruminant animal. Patent assigned to Grain States Soya, Inc. and used in the manufacture of SoyBest.

U.S. Pat. No. 7,318,943 describes a feed supplement for increasing the plasma amino acid level of animals, including animal feed and liquid lysine base, where the liquid lysine base has a concentration between about 45% and about 55%, and has a pH level of between about 9.5 and about 10.5, a chloride content between about 0.10% and about 0.15%, a bulk density of between about 1.14 and about 1.17 g/cm, and a maximum moisture level of between about 42% and about 48%. The animal feed may either be dry feed, liquid feed, drinking water or milk replacers, or a combination thereof. The present invention also includes a method of increasing the plasma amino acid level of animals, including the steps of providing animal feed, and Supplementing the animal feed with an amino acid Supplement comprising liquid lysine base having a concentration between about 45% and about 55%, and having a pH level of between about 9.5 and about 10.5. The '943 patent is assigned to ADM and apparently has not been practiced commercially.

U.S. Pat. No. 10,076,127 describes processes for increasing rumen undegraded protein in protein-containing compositions, fermentation by-products, or combinations thereof. Uses of alkaline crystalline solids to increase rumen undegraded protein in protein containing compositions, fermentation by-products or combinations thereof are further disclosed. Products produced from such processes are also disclosed. The '127 patent assigned to ADM and not commercially practiced to date.

### SUMMARY

Disclosed embodiments of the present invention concern a new and improved method for preparing a high-quality protein product having an improved rumen escape amino acid index, and a protein product made according to the method. Certain disclosed embodiments concern a method for manufacturing a mixture of feeds to make them less digestible in the rumen. The processed mixture of proteins improves the rumen escape amino acids provided to a ruminant animal fed a prepared feed. The resulting benefit is an improvement in the efficiency of converting feed protein to lean tissue gain and milk protein.

Certain disclosed embodiments of the method comprise mixing selected protein sources to produce a protein mixture having an amino acid pattern that aligns with ruminant lean tissue, milk protein, or both. The initial protein sources may be selected to form a mixture having a complimentary rumen escape amino acid index (REAAi). Processing aids may be, and typically are, added to the protein mixture to facilitate production of a desired product. Processing aids may, for example, facilitate non-enzymatic browning of proteins provided by the protein sources. Non-enzymatic browning of proteins supports formation of Maillard reaction products. A solvent also may be included, and typically is included, to form a solvent mixture. Suitable solvents include, but are not limited to, water, glycerin, glycerol, high fructose corn syrup, liquid whey, and combinations thereof. Solvent is added at a suitable amount, such as 1 wt % to at least 15 wt %. The resulting mixture is then preferably agitated and/or heated and subsequently dried to form a dried protein mixture having a suitable moisture content, such as from 2 wt % to 12 wt %, typically 6 wt % to 8 wt %. The dried protein mixture is processed to produce a final dry mixture having a desired particle size, such as from 800 to 1200 microns.

Protein sources can be obtained from any suitable source, such as oil seeds, grains, pulses, legumes, animal proteins, grain processing coproducts, gluten feed, and gluten meal, with particular examples of protein sources including soybean meal, canola meal, cottonseed meal, and combinations thereof. The method also can include mixing a meal with the protein mixture to form a meal-protein mixture. This may be particularly beneficial when the meal is from a prior process that has been heated to a meal temperature sufficient to advantageously increase the temperature of the resulting meal protein mixture.

Any suitable processing aid may be used, including by way of example and without limitation, yeast, reactive sugars, protease enzymes, metal ions, and combinations thereof. For certain exemplary embodiments, the processing aids were selected from: (a) from 0.5 wt % to 2 wt % of an inactivated yeast, such as saccharomyces yeast, to provide reactive sugars found in the yeast cell wall and cell soluble fraction; (b) 0.5 wt % to 3 wt % of reducing sugars; (c) 0.01 to 0.2 wt % of a protease enzyme; (d) 500 to 1,000 ppm, such as 750 ppm, of a soluble metal; and (e) combinations thereof. Sugar in the yeast cell wall, including baker's yeast, typically is galactose, whereas sugar in the cell soluble fraction typically is ribose. Reducing sugar(s) may be provided by cane molasses and include xylose, glucose, sucrose, glucose, or combinations thereof. The metal ion may be a divalent metal ion, such as Zn, Cu or Fe. A specific example of a Zn source is ZnSO₄.

The method may include additional steps. For example, the method may further comprise adding additional materials to the mixture, including amino acids, such as lysine, methionine, and combinations thereof, soluble proteins, fermentation cell masses, lipids, glycerin, liquid molasses, calcium oxide, and combinations thereof. The method also may further comprise tempering the final mixture.

The method improves the rumen undegradable protein (RUP) % of the mixture. For certain embodiments, the RUP content of the mixture was increased by up to 30% compared to unprocessed mixtures. With reference to more specific examples, for mechanically extracted soybean meal, the soybean meal RUP was increased by the process by about 20%. For solvent extracted soybean meal, the soybean meal RUP was increased by the process by about 30%. And for cottonseed meal, the RUP was increased by the process by about 18%.

The method also beneficially affects REAA. In one illustrative example, processing the protein mixture increased REAA by 39 grams per kg of dry weight. In another example, processing improved the mean REAAi for (Met+Lys+His), the three amino acids considered most limiting for milk protein synthesis.

Disclosed embodiments also include products made by the method.

Furthermore, products made by the method are administered to a feed animal, such as a ruminant.

### BRIEF DESCRIPTION OF THE DRAWING

FIG. 1 is a schematic drawing illustrating one embodiment of a process for making a protein product according to the present invention.

### DETAILED DESCRIPTION

### I. Terms

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods as known to those of ordinary skill in the art. When directly and explicitly distinguishing embodiments from discussed prior art, the embodiment numbers are not approximates unless the word “about” is recited.

Ruminant: Examples of animals that can be fed products according to the present invention include ruminant species, such as a sheep, goat, bovine (such as a cow, bull, steer, heifer, calf, bison, or buffalo), deer, bison, buffalo, elk, alpaca, camel or llama.

### II. Discussion of Disclosed Embodiments

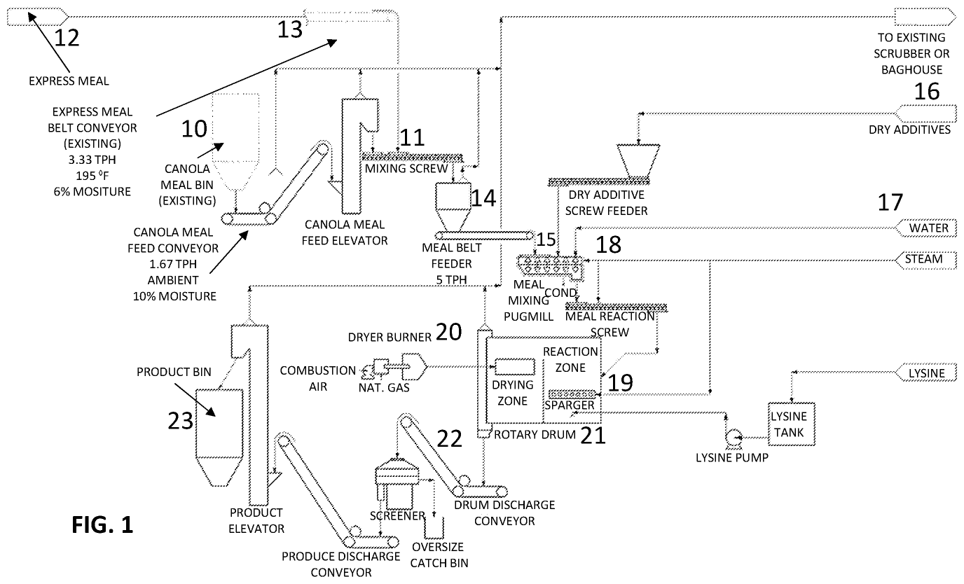

Reference numbers 10-13 of FIG. 1 illustrate mixing protein sources to produce a protein mixture having an amino acid pattern aligned with the profile of amino acids in ruminant lean tissue or milk protein or both. The proteins used in the mixture are to optimize the profile of amino acids of the mixture compared with the profile of any single protein. The protein sources may be selected from various classes of ingredients such as oil seeds, grains, pulses, legumes, animal proteins and grain processing coproducts such as distiller's grains, gluten feed, or gluten meal. Exemplary oil seed meals include soybean meal, canola meal, and cottonseed meal. With reference to FIG. 1, the protein sources are stored in bulk as shown at 10 and gravimetrically fed to a mixing screw 11. Optionally, a meal from prior process 12 that has been substantially heated may be used in the feed mixture. The meal temperature may range between 160° F. to 250° F. during conveyance at 13. The latent heat of the prior process is advantageously used to elevate the temperature of the subsequent mixture to which the heated material is added.

Reference numbers 14-18 of FIG. 1 illustrate moistening, heating, and adding processing aids. Materials are conveyed from a surge bin 14 to a mixing unit 15. The illustrated mixing unit is a pug mill, but a person of ordinary skill in the art will understand that other suitable mixing devices can be used. Optionally, the pug mill may be jacketed and/or heated, such as oil heated, to an effective processing temperature, such as a temperature of 300° F. to 400° F. Processing aids shown in 16 are metered into the mixing unit to aid in the non-enzymatic browning of the proteins. Non-enzymatic browning, or the Maillard reaction, involves condensation of amino groups found in proteins, peptides and amino acids, with carbonyl groups of reducing sugars, resulting in the formation of Maillard reaction products. Without being bound by a theory of operation, the formation of Maillard products may change the tertiary structure of the proteins to advantageously reduce solubility of the proteins in aqueous environments, such as the rumen. This reduces exposure of the proteins to ruminal enzymes that would normally degrade the proteins and diminish flow of intact protein from the rumen. The protection of protein from rumen degradation thereby enables more of the protein to pass from the rumen and be digested in the small intestine. The net benefit is that more amino acids are provided to the intestines for absorption and utilization by the animal.

The processing aids may be dry powders, granules, liquids, or combinations thereof. Water is concomitantly added at 17 with processing aids in an amount ranging from about 15 wt. % to 30 wt. % of the combined feed solids mixture to give a moist meal. Optionally, other solvents can partly substitute water, including glycerin, crude glycerol, high fructose corn syrup, and liquid whey, which may be added at 1 wt % to 15 wt %. The dry solids and liquids are mixed for a period of time sufficient to form a uniform moist meal, for example, 30 seconds to 5 minutes and moist meal feed is discharged to a jacketed continuous flow auger fitted with steam injection ports at 18. While being continuously agitated in the auger for a period of 5 to 7 minutes the temperature of the moist meal is increased to 160° F. to 250° F. by any suitable method, such as by using steam. Optionally the auger may also be jacketed and oil heated. The wetting and heating are continuously monitored. Again, without being bound by a particular theory of operation, the wetting and heating are continuously monitored to activate the processing aids and accelerate formation of reactive α-dicarbonyl molecules which act as catalysts in the Maillard reaction process.

The processing aids are selected from a class of ingredients having beneficial properties for acting in or accelerating non-enzymatic browning of proteins. Inactivated saccharomyces yeast is used in amounts of 0.5 to 2 wt % to provide reactive sugars found in the yeast cell wall (galactose) and cell soluble fraction (ribose). Additional amounts (0.5 to 3 wt %) of reducing sugars (xylose, glucose, sucrose, glucose) may be added in dry form or as liquids. An exemplary source of reducing sugar includes cane molasses. A protease enzyme is selected and added to the processing aid mixture at 0.01 to 0.2 wt %. As a general class, protease enzymes are capable of partly or completely hydrolyzing proteins to constituent amino acids and peptides. The extent of hydrolysis is dependent on enzyme activity (units/wt), concentration and processing conditions (water activity, temperature, pH, time). A soluble metal ion is selected and added to the processing aid mixture at 500 to 1,000 ppm, more preferably 750 ppm. Divalent metal ions (Zn, Cu, Fe) are known to form complexes with Maillard reaction products thereby enhancing the catalytic properties of the reaction products and accelerating the overall non-enzymatic browning process. The concentration of ions referenced are preferred over higher concentrations because of favorable effects of the ion on Maillard complex formation when used at concentrations referenced. Higher concentrations of ion potentially retard the browning process by forming inhibitory complexes. An exemplary soluble form of divalent metal ion is ZnSO₄.

The protein mixture is then dried, as illustrated by reference numbers 19-22 of FIG. 1. The moistened and heated mixture is conveyed to a high temperature reactor 19. In this illustration the reactor is shown as a drum reactor-dryer. The reactor is fitted with adjustable dams and lifting and mixing flights and set on variable slope to control the level and flow of material in the reactor. The reactor is operated on a trunnion, thereby enabling continuous and variable rotation of the reactor, affording intimate contacting of the mixture with the hot air stream and walls of the reactor. Other suitable reactors include thin film heat exchangers, stacked disc heaters, and heated screws. The physical configuration of the reactor preferably heats and maintains the mixture to a temperature within the range of 200° F. to 350° F. for a period of between 5 minutes and 90 minutes in order to complete reactions which result in changes to the solubility and tertiary structure of the mixture. The reactor may be heated by any suitable method, such as by using a gas burner 20 supplying air heated to a temperature ranging from about 300° F. to 600° F. with air velocity into the reactor of about 10 to 60 mHz. Optionally the reactor may be jacketed and heated by oil. In certain embodiments a combination of heating methods may be used. A preferable temperature range for the mixture in the reactor is between about 220° F. and 300° F., while the most desirable range is between about 250° F. and 275° F. Likewise, a more preferable period of exposure is between 20 minutes and 60 minutes, with a typical retention time of 20 minutes to 40 minutes. The moist cooked mixture is then dried at conditions of temperature and time sufficient to give a dried meal having a moisture content of about 2 to 12 wt %. During the drying step, liquids are optionally applied and mixed with the meal via a spray system at 21. The liquids may include but are not limited to amino acids, soluble proteins, fermentation cell masses, and lipids. Exemplary amino acids include liquid lysine and liquid methionine. A preferable moisture content of the mixture is between 4 wt % and 10 wt % and the most preferred is 6 wt % to 8 wt %. The dry mixture is discharged from the reactor onto a conveyor 22 fitted with a roller mill and screen system to produce a final dry mixture with particle size of about 800 to 1200 microns. The temperature of the mixture at discharge is about 220° F. down to 160° F. with a preferable temperature of between 200° F. to 180° F.

The dry, high temperature cooked mixture is conveyed to a storage vessel for tempering at 23. Tempering is advantageous for completing the reaction process in a manner intended to prevent degradation in the nutritive value of sensitive nutrients added at 21. This is especially relevant for amino acids, e.g., lysine. The storage vessel may be a bulk bin, tote, fiber drum or metal drum. The mixture is held for 2 hours to 72 hours, preferably 12 hours to 24 hours. Eventually the mixture cools to ambient temperature with moisture content in the preferred range of 6 to 8 wt %. The cooled protein mixture is then conveyed to a truck, train, or any other transportation means for sale and use.

### III. Examples

The following examples are provided to illustrate various features and embodiments of the present disclosure and are not intended to restrict the scope of the invention as described or claimed herein. Unless described otherwise, the rumen undegradable protein (RUP) content of compositions was determined by weighing compositions into porous dacron bags and incubating the bags in the rumens of lactating dairy cows for a period of 16 hours. The protein content of the residue remaining after the incubation was defined as the rumen undegraded protein fraction of the composition. The rumen undegradable amino acid content of the composition was determined by multiplying the amino acid concentration of the composition by the percentage of protein determined to be rumen undegradable.

### Example 1

This example describes the calculation of rumen escape amino acid content for ingredients. The example further illustrates calculating a rumen escape index for ingredients by comparing the ingredient amino acid profile to that of lean tissue or milk protein. The initial or native characteristics of feed ingredients commonly used to form feed mixtures is presented in the table below. The essential amino acid content of the ingredients was derived from available feed library tables and the amino acid contents are expressed as percentages of the protein. The RUP for ingredients is presented with ranges derived from the inventor's experience and from published reports. The range in RUP illustrates the potential variability of ingredients prior to use in the invention described herein.

The rumen escape amino acid index (REAAi) for ingredients relative to lean tissue or milk protein is calculated as follows:

REAAi=(RUP×AA)/Tissue or Milk AA

Rumen escape amino acid content (REAA) can be calculated using the following equation:

REAA (g/kg of dry weight)=CP (% of DM)×Amino acid (% of CP)×RUP (% of CP)/1000

with RUP and AA expressed as percentages of crude protein.

A mean REAAi is calculated by summing the individual amino acid REAAi and dividing by the number of amino acids used in the calculation. For example, if all essential amino acids are used, then the sum of the REAAi is divided by 10 to calculate the mean REAAi for an ingredient.

Table 1 provides an estimate of the REAA (g/kg) for selected ingredients. Only the essential amino acids are illustrated as these are of primary interest in practice.

As noted by Table 1, protein degradation in the rumen (i.e., low RUP) reduces REAA, thereby reducing the utility of the ingredient as a source of rumen escape amino acids. It is therefore advantageous to process ingredients to increase the RUP percentage, thereby increasing REAA and enabling a greater amount of essential amino acids to flow past the rumen for absorption and utilization by the animal. As a result of differences in amino acid profile, ingredients provide different amounts of specific amino acids at a given RUP %. For example, at 80% RUP, solvent-extracted soybean meal provides three times the amount of rumen escape lysine than corn gluten meal (26 g vs 9 g), whereas gluten meal provides about twice the amount of rumen escape methionine.

Therefore, it is advantageous to first form a mixture of ingredients with complementary REAAi and to then process the mixture according to the methods described herein to improve the RUP % of the mixture. Advantageously both amount and profile of amino acids provided to the ruminant animal are thereby improved. This method represents an improvement over prior art describing methods of forming RUP in single ingredients, such as soybean meal, without regard to optimizing the profile of the RUP itself.

TABLE 1

| | CP, % | REAA, g/Kg of Dry Weight | | | | | | | | | | |
|---|---|---|---|---|---|---|---|---|---|---|---|---|
| Item | of DM | Met | Lys | Arg | Thr | Leu | Ile | Val | His | Phe | Trp | Sum |
| Solvent extracted | 53 | 1.34 | 6.11 | 7.30 | 3.89 | 7.59 | 4.54 | 4.73 | 3.64 | 5.06 | 1.34 | |
| soybean meal, AA, | | | | | | | | | | | | |
| % of protein | | | | | | | | | | | | |
| 20% RUP | | 1.4 | 6.5 | 7.7 | 4.1 | 8.0 | 4.8 | 5.0 | 3.8 | 5.3 | 1.4 | 48.1 |
| 40% RUP | | 2.8 | 12.9 | 15.4 | 8.2 | 16.0 | 9.6 | 10.0 | 7.7 | 10.7 | 2.8 | 96.2 |
| 60% RUP | | 4.2 | 19.4 | 23.1 | 12.3 | 24.1 | 14.4 | 15.0 | 11.5 | 16.0 | 4.2 | 144.3 |
| 80% RUP | | 5.7 | 25.8 | 30.8 | 16.4 | 32.1 | 19.2 | 20.0 | 15.4 | 21.4 | 5.7 | 192.4 |
| Mechanically | 51 | 1.54 | 5.85 | 6.54 | 3.96 | 7.71 | 4.62 | 4.81 | 2.94 | 5.13 | 1.29 | |
| processed soybean | | | | | | | | | | | | |
| meal AA, | | | | | | | | | | | | |
| % of protein | | | | | | | | | | | | |
| 60% RUP | | 4.8 | 18.2 | 20.4 | 12.4 | 24.1 | 14.4 | 15.0 | 9.2 | 16.0 | 4.0 | 138.5 |
| 80% RUP | | 6.4 | 24.3 | 27.2 | 16.5 | 32.1 | 19.2 | 20.0 | 12.2 | 21.4 | 5.4 | 184.6 |
| Solvent extracted | 42 | 1.96 | 5.50 | 5.92 | 4.42 | 6.90 | 3.93 | 5.10 | 2.65 | 3.99 | 1.34 | |
| canola meal AA, | | | | | | | | | | | | |
| % of protein | | | | | | | | | | | | |
| 20% RUP | | 1.6 | 4.6 | 5.0 | 3.7 | 5.8 | 3.3 | 4.3 | 2.2 | 3.4 | 1.1 | 35.0 |
| 40% RUP | | 3.3 | 9.2 | 9.9 | 7.4 | 11.6 | 6.6 | 8.6 | 4.5 | 6.7 | 2.3 | 70.1 |
| 60% RUP | | 4.9 | 13.8 | 14.9 | 11.1 | 17.4 | 9.9 | 12.9 | 6.7 | 10.1 | 3.4 | 105.1 |
| 80% RUP | | 6.6 | 18.5 | 19.9 | 14.8 | 23.2 | 13.2 | 17.1 | 8.9 | 13.4 | 4.5 | 140.1 |
| Cottonseed meal AA, | 41 | 1.60 | 4.54 | 13.25 | 3.49 | 6.34 | 3.44 | 4.84 | 3.12 | 6.04 | 1.40 | |
| % of protein | | | | | | | | | | | | |
| 40% RUP | | 2.6 | 7.4 | 21.7 | 5.7 | 10.4 | 5.6 | 7.9 | 5.1 | 9.9 | 2.3 | 78.8 |
| 60% RUP | | 6.4 | 18.3 | 53.5 | 14.1 | 25.6 | 13.9 | 19.5 | 12.6 | 24.4 | 5.6 | 193.9 |
| Peanut meal AA, | 50 | 1.03 | 3.21 | 11.01 | 2.56 | 6.14 | 3.21 | 3.88 | 2.22 | 4.81 | 1.03 | |
| % of protein | | | | | | | | | | | | |
| 40% RUP | | 2.1 | 6.4 | 21.9 | 5.1 | 12.2 | 6.4 | 7.7 | 4.4 | 9.6 | 2.1 | 77.9 |
| 60% RUP | | 3.1 | 9.6 | 32.9 | 7.7 | 18.4 | 9.6 | 11.6 | 6.6 | 14.4 | 3.1 | 116.9 |
| Corn distiller's | 30 | 1.98 | 2.81 | 4.30 | 3.73 | 11.67 | 3.65 | 4.87 | 2.66 | 4.87 | 0.80 | |
| dried grains AA, | | | | | | | | | | | | |
| % of protein | | | | | | | | | | | | |
| 40% RUP | | 2.4 | 3.4 | 5.2 | 4.5 | 14.2 | 4.4 | 5.9 | 3.2 | 5.9 | 1.0 | 50.3 |
| 60% RUP | | 3.6 | 5.1 | 7.8 | 6.8 | 21.3 | 6.7 | 8.9 | 4.9 | 8.9 | 1.5 | 75.4 |
| 80% RUP | | 4.8 | 6.8 | 10.4 | 9.1 | 28.4 | 8.9 | 11.8 | 6.5 | 11.8 | 1.9 | 100.5 |
| Corn gluten meal AA, | 66 | 2.38 | 1.64 | 3.14 | 3.34 | 16.35 | 3.98 | 4.51 | 2.02 | 6.18 | 0.54 | |
| % of protein | | | | | | | | | | | | |
| 60% RUP | | 9.5 | 6.5 | 12.5 | 13.3 | 64.9 | 15.8 | 17.9 | 8.0 | 24.6 | 2.2 | 175.1 |
| 80% RUP | | 12.6 | 8.7 | 16.6 | 17.7 | 86.6 | 21.1 | 23.9 | 10.7 | 32.8 | 2.9 | 233.5 |
| Blood meal AA, | 95 | 1.15 | 8.77 | 4.20 | 4.55 | 12.40 | 1.08 | 8.32 | 6.00 | 6.79 | 1.58 | |
| % of protein | | | | | | | | | | | | |
| 60% RUP | | 6.6 | 50.0 | 24.0 | 25.9 | 70.7 | 6.1 | 47.4 | 34.2 | 38.7 | 9.0 | 312.6 |
| 80% RUP | | 8.8 | 66.6 | 32.0 | 34.6 | 94.2 | 8.2 | 63.2 | 45.6 | 51.6 | 12.0 | 416.8 |

The REAAi of feed ingredients at varying RUP % relative to lean tissue is presented by Tables 2 and 3, below.

TABLE 2

| | REAAi, % | | | | | | | | | | | | |
|---|---|---|---|---|---|---|---|---|---|---|---|---|---|
| | | | | | | | | | | | | Met + Lys + | |
| | | | | | | | | | | | Average | His + Thr + | Met + Lys + |
| | Met | Lys | Arg | Thr | Leu | Ile | Val | His | Phe | Trp | EAAi | Ile | Arg |
| Lean tissue AA, | 1.97 | 6.37 | 6.6 | 3.9 | 6.7 | 2.84 | 4 | 2.47 | 6.18 | 0.49 | | | |
| % of protein | | | | | | | | | | | | | |
| Solvent extracted | 1.34 | 6.11 | 7.30 | 3.89 | 7.59 | 4.54 | 4.73 | 3.64 | 5.06 | 1.34 | | | |
| soybean meal AA, | | | | | | | | | | | | | |
| % of protein | | | | | | | | | | | | | |
| 20% RUP | 14 | 19 | 22 | 20 | 23 | 32 | 24 | 29 | 16 | 55 | 25 | 23 | 18 |
| 40% RUP | 27 | 38 | 44 | 40 | 45 | 64 | 47 | 59 | 33 | 109 | 51 | 47 | 37 |
| 60% RUP | 41 | 58 | 66 | 60 | 68 | 96 | 71 | 88 | 49 | 164 | 76 | 70 | 55 |
| 80% RUP | 54 | 77 | 89 | 80 | 91 | 128 | 95 | 118 | 65 | 219 | 101 | 93 | 73 |
| Mechanically | 1.54 | 5.85 | 6.54 | 3.96 | 7.71 | 4.62 | 4.81 | 2.94 | 5.13 | 1.29 | | | |
| processed soybean | | | | | | | | | | | | | |
| meal AA, | | | | | | | | | | | | | |
| % of protein | | | | | | | | | | | | | |
| 60% RUP | 47 | 55 | 59 | 61 | 69 | 98 | 72 | 71 | 50 | 158 | 74 | 68 | 54 |
| 80% RUP | 62 | 73 | 79 | 81 | 92 | 130 | 96 | 95 | 66 | 210 | 99 | 91 | 72 |
| Solvent extracted | 1.96 | 5.50 | 5.92 | 4.42 | 6.90 | 3.93 | 5.10 | 2.65 | 3.99 | 1.34 | | | |
| canola meal AA, | | | | | | | | | | | | | |
| % of protein | | | | | | | | | | | | | |
| 20% RUP | 20 | 17 | 18 | 23 | 21 | 28 | 26 | 21 | 13 | 55 | 24 | 21 | 18 |
| 40% RUP | 40 | 35 | 36 | 45 | 41 | 55 | 51 | 43 | 26 | 109 | 48 | 43 | 37 |
| 60% RUP | 60 | 52 | 54 | 68 | 62 | 83 | 77 | 64 | 39 | 164 | 72 | 64 | 55 |
| 80% RUP | 80 | 69 | 72 | 91 | 82 | 111 | 102 | 86 | 52 | 219 | 96 | 85 | 73 |
| Cottonseed meal AA, | 1.60 | 4.54 | 13.25 | 3.49 | 6.34 | 3.44 | 4.84 | 3.12 | 6.04 | 1.40 | | | |
| % of protein | | | | | | | | | | | | | |
| 40% RUP | 32 | 29 | 80 | 36 | 38 | 49 | 48 | 51 | 39 | 114 | 52 | 40 | 47 |
| 60% RUP | 49 | 43 | 120 | 54 | 57 | 73 | 73 | 76 | 59 | 171 | 77 | 59 | 71 |
| Peanut meal AA, | 1.03 | 3.21 | 11.01 | 2.56 | 6.14 | 3.21 | 3.88 | 2.22 | 4.81 | 1.03 | | | |
| % of protein | | | | | | | | | | | | | |
| 40% RUP | 21 | 20 | 67 | 26 | 37 | 45 | 39 | 36 | 31 | 84 | 41 | 32 | 36 |
| 60% RUP | 32 | 30 | 100 | 39 | 55 | 68 | 58 | 54 | 47 | 127 | 61 | 48 | 54 |
| Corn distiller's | 1.98 | 2.81 | 4.30 | 3.73 | 11.67 | 3.65 | 4.87 | 2.66 | 4.87 | 0.80 | | | |
| dried grains AA, | | | | | | | | | | | | | |
| % of protein | | | | | | | | | | | | | |
| 40% RUP | 40 | 18 | 26 | 38 | 70 | 51 | 49 | 43 | 31 | 65 | 43 | 44 | 28 |
| 60% RUP | 60 | 27 | 39 | 57 | 105 | 77 | 73 | 65 | 47 | 98 | 65 | 67 | 42 |
| 80% RUP | 80 | 35 | 52 | 76 | 139 | 103 | 97 | 86 | 63 | 130 | 86 | 89 | 56 |
| Corn gluten meal AA, | 2.38 | 1.64 | 3.14 | 3.34 | 16.35 | 3.98 | 4.51 | 2.02 | 6.18 | 0.54 | | | |
| % of protein | | | | | | | | | | | | | |
| 60% RUP | 73 | 15 | 29 | 51 | 146 | 84 | 68 | 49 | 60 | 66 | 64 | 74 | 39 |
| 80% RUP | 97 | 21 | 38 | 68 | 195 | 112 | 90 | 66 | 80 | 89 | 86 | 98 | 52 |
| Blood meal AA, | 1.15 | 8.77 | 4.20 | 4.55 | 12.40 | 1.08 | 8.32 | 6.00 | 6.79 | 1.58 | | | |
| % of protein | | | | | | | | | | | | | |
| 60% RUP | 35 | 83 | 38 | 70 | 111 | 23 | 125 | 146 | 66 | 194 | 89 | 79 | 52 |
| 80% RUP | 47 | 110 | 51 | 93 | 148 | 30 | 166 | 194 | 88 | 258 | 119 | 106 | 69 |

The REAAi for ingredients, in relation to the profile of milk protein is presented by Table 3, below.

TABLE 3

| | REAAi, % | | | | | | | | | | | | |
|---|---|---|---|---|---|---|---|---|---|---|---|---|---|
| | | | | | | | | | | | | Met + Lys + | |
| Item | | | | | | | | | | | | His + Leu + | Met + Lys + |
| Amino acid | Met | Lys | Arg | Thr | Leu | Ile | Val | His | Phe | Trp | EAAi | Ile | Arg |
| Milk protein AA, | 2.71 | 7.62 | 3.4 | 3.72 | 9.18 | 5.79 | 5.89 | 2.74 | 6.79 | 1.51 | | | |
| % of protein | | | | | | | | | | | | | |
| Solvent extracted | 1.34 | 6.11 | 7.30 | 3.89 | 7.59 | 4.54 | 4.73 | 3.64 | 5.06 | 1.34 | | | |
| soybean meal AA, | | | | | | | | | | | | | |
| % of protein | | | | | | | | | | | | | |
| 20% RUP | 10 | 16 | 43 | 21 | 17 | 16 | 16 | 27 | 15 | 18 | 20 | 17 | 23 |
| 40% RUP | 20 | 32 | 86 | 42 | 33 | 31 | 32 | 53 | 30 | 35 | 39 | 34 | 46 |
| 60% RUP | 30 | 48 | 129 | 63 | 50 | 47 | 48 | 80 | 45 | 53 | 59 | 51 | 69 |
| 80% RUP | 40 | 64 | 172 | 84 | 66 | 63 | 64 | 106 | 60 | 71 | 79 | 68 | 92 |
| Mechanically | 1.54 | 5.85 | 6.54 | 3.96 | 7.71 | 4.62 | 4.81 | 2.94 | 5.13 | 1.29 | | | |
| processed soybean | | | | | | | | | | | | | |
| meal AA, | | | | | | | | | | | | | |
| % of protein | | | | | | | | | | | | | |
| 60% RUP | 34 | 46 | 115 | 64 | 50 | 48 | 49 | 64 | 45 | 51 | 57 | 49 | 65 |
| 80% RUP | 45 | 61 | 154 | 85 | 67 | 64 | 65 | 86 | 60 | 68 | 76 | 65 | 87 |
| Solvent extracted | 1.96 | 5.50 | 5.92 | 4.42 | 6.90 | 3.93 | 5.10 | 2.65 | 3.99 | 1.34 | | | |
| canola meal AA, | | | | | | | | | | | | | |
| % of protein | | | | | | | | | | | | | |
| 20% RUP | 14 | 14 | 35 | 24 | 15 | 14 | 17 | 19 | 12 | 18 | 18 | 15 | 21 |
| 40% RUP | 29 | 29 | 70 | 47 | 30 | 27 | 35 | 39 | 23 | 36 | 36 | 31 | 42 |
| 60% RUP | 43 | 43 | 104 | 71 | 45 | 41 | 52 | 58 | 35 | 53 | 55 | 46 | 64 |
| 80% RUP | 58 | 58 | 139 | 95 | 60 | 54 | 69 | 77 | 47 | 71 | 73 | 61 | 85 |
| Cottonseed meal AA, | 1.60 | 4.54 | 13.25 | 3.49 | 6.34 | 3.44 | 4.84 | 3.12 | 6.04 | 1.40 | | | |
| % of protein | | | | | | | | | | | | | |
| 40% RUP | 24 | 24 | 156 | 38 | 28 | 24 | 33 | 46 | 36 | 37 | 44 | 29 | 68 |
| 60% RUP | 35 | 36 | 234 | 56 | 41 | 36 | 49 | 68 | 53 | 56 | 67 | 43 | 102 |
| Peanut meal AA, | 1.03 | 3.21 | 11.01 | 2.56 | 6.14 | 3.21 | 3.88 | 2.22 | 4.81 | 1.03 | | | |
| % of protein | | | | | | | | | | | | | |
| 40% RUP | 15 | 17 | 130 | 28 | 27 | 22 | 26 | 32 | 28 | 27 | 35 | 23 | 54 |
| 60% RUP | 23 | 25 | 194 | 41 | 40 | 33 | 40 | 49 | 42 | 41 | 53 | 34 | 81 |
| Corn distiller's | 1.98 | 2.81 | 4.30 | 3.73 | 11.67 | 3.65 | 4.87 | 2.66 | 4.87 | 0.80 | | | |
| dried grains AA, | | | | | | | | | | | | | |
| % of protein | | | | | | | | | | | | | |
| 40% RUP | 29 | 15 | 51 | 40 | 51 | 25 | 33 | 39 | 29 | 21 | 33 | 32 | 32 |
| 60% RUP | 44 | 22 | 76 | 60 | 76 | 38 | 50 | 58 | 43 | 32 | 50 | 48 | 47 |
| 80% RUP | 58 | 30 | 101 | 80 | 102 | 50 | 66 | 78 | 57 | 42 | 66 | 64 | 63 |
| Corn gluten meal AA, | 2.38 | 1.64 | 3.14 | 3.34 | 16.35 | 3.98 | 4.51 | 2.02 | 6.18 | 0.54 | | | |
| % of protein | | | | | | | | | | | | | |
| 60% RUP | 53 | 13 | 55 | 54 | 107 | 41 | 46 | 44 | 55 | 22 | 49 | 52 | 40 |
| 80% RUP | 70 | 17 | 74 | 72 | 142 | 55 | 61 | 59 | 73 | 29 | 65 | 69 | 54 |
| Blood meal AA, | 1.15 | 8.77 | 4.20 | 4.55 | 12.40 | 1.08 | 8.32 | 6.00 | 6.79 | 1.58 | | | |
| % of protein | | | | | | | | | | | | | |
| 60% RUP | 26 | 69 | 74 | 73 | 81 | 11 | 85 | 131 | 60 | 63 | 67 | 64 | 56 |
| 80% RUP | 34 | 92 | 99 | 98 | 108 | 15 | 113 | 175 | 80 | 84 | 90 | 85 | 75 |

Notably, individual ingredients have low REAAi at low RUP %, and certain of the ingredients exhibit relatively imbalanced amino acid profiles even at higher amounts of RUP %, as evidenced by low REAAi. In general, soy protein exhibits a favorable profile and higher REAAi whereas corn proteins and other oilseed meals (e.g., peanut meal) have lower REAAi, owing to deficits in key essential amino acids such as lysine, methionine, and histidine. These limitations may be overcome by mixing ingredients with complementary amino acid profiles followed by processing of the mixture to increase the RUP content thereby increasing the amount of protein escaping degradation in the rumen while providing a higher REAAi than would otherwise be obtained by processing an individual ingredient.

### Example 2

In this example the effects of processing aids on the rumen undegraded protein content of mechanically extracted soybean meal processed with or without agitation during the reaction-drying step was determined. For the no agitation method, 1,000 grams of soybean meal were mixed for three to five minutes in a laboratory mixer with varying amounts of processing aids and then weighed into aluminum pans, covered with foil, and placed in a 105° C. oven for four hours. After the four hours, the foil was removed, and the mixtures were placed in a 55° C. oven and dried to less than 10% moisture. For the agitation method, five kilograms of soybean meal was mixed with processing aids in a high intensity laboratory mixer (Eirich Machines, Inc. Gurnee, IL) for various durations. The mixture was heated to 210° F. to 220° F. using a heat gun to supply indirect heat to the material while in the rotating mixer. After agitation the composition was discharged from the mixer and cooled to ambient temperature before sampling.

The effects of method of processing and processing aids on the rumen undegraded protein (RUP) content of mechanically extracted soybean meal is shown by Table 4. The control and treatments 1-6 were tested without agitation whereas treatments 7-8 were tested with agitation.

TABLE 4

| Treatment | Dry matter, % | Protein, % of DM | RUP, % of CP |
|---|---|---|---|
| Control | 94.4 | 47.7 | 63.3 |
| 1 | 87.4 | 55.1 | 77.0 |
| 2 | 89.3 | 54.0 | 76.8 |
| 3 | 95.3 | 53.2 | 74.9 |
| 4 | 88.0 | 52.4 | 71.8 |
| 5 | 91.7 | 47.1 | 72.3 |
| 6 | 90.0 | 47.6 | 72.4 |
| 7 | 95.3 | 46.1 | 73.5 |
| 8 | 95.9 | 46.4 | 71.8 |

Description of treatments:
Control = 25% water (vol/wt);
1 = 25% water, 1% baker's yeast (wt/wt);
2 = 25% water, 2% baker's yeast (wt/wt);
3 = 25% water, 0.5% baker's yeast (wt/wt), 750 ppm Zn;
4 = 15% water, 3% crude glycerin (vol/wt), 3% liquid molasses (vol/wt);
5 = 25% water, 2% brewer's yeast;
6 = 25% water, 1% brewer's yeast, 750 ppm Zn;
7 = 20% water, 10% crude glycerin (vol/wt) 0.5% baker's yeast, 750 ppm Zn agitated for 15 minutes; and
8 = 20% water, 10% crude glycerin (vol/wt) 0.5% baker's yeast, 750 ppm Zn agitated for 30 minutes.

Combining the meal with processing aids increased the RUP content over the control meal, which was only wetted before heating. Baker's yeast was particularly effective at causing formation of RUP and the addition of Zn ion with a lower amount of baker's yeast resulted in RUP approaching that measured for the higher amounts of baker's yeast addition. The study showed that crude glycerin and liquid molasses could partly substitute water in the process, thereby enabling formation of RUP while providing usable energy (glycerol, sugar) to the final composition. An inactivated dry brewer's yeast used in combination with Zn ion proved efficacious for RUP formation. This result demonstrated that yeast was beneficial despite being an inactivate form, that is, having no colony forming capacity or metabolic activity. The agitation of the composition resulted in favorable RUP formation with 15 to 30 minutes of processing thereby demonstrating benefits for continuously mixing the composition during the reaction to, for example, elicit Maillard product formation in less time than would otherwise be achieved in a non-agitated process.

### Example 3

The effects of processing aids on the rumen undegraded protein content of solvent-extracted cottonseed meal was determined. About 1,000 grams of cottonseed meal was mixed for three to five minutes in a laboratory mixer with varying amounts of processing aids. The composition was weighed into aluminum pans, covered with foil, and placed in a 105° C. oven for four hours. After the four hours, the foil was removed, and the mixtures were placed in a 55° C. oven and dried to less than 10% moisture.

The rumen undegraded protein (RUP) content of treated cottonseed meal is shown by Table.

TABLE 5

| Treatment | Dry matter, % | Protein, % of DM | RUP, % of CP |
|---|---|---|---|
| Native meal | 89.6 | 48.5 | 46.2 |
| 1 | 92.7 | 48.5 | 57.5 |
| 2 | 89.0 | 52.8 | 64.5 |
| 3 | 89.6 | 51.1 | 66.5 |
| 4 | 90.4 | 50.8 | 61.3 |
| 5 | 88.6 | 52.7 | 58.7 |
| 6 | 88.2 | 51.9 | 63.8 |
| 7 | 90.4 | 47.8 | 66.4 |

Description of treatments
Native meal = solvent-extracted cottonseed meal;
1 = 25% water (vol/wt);
2 = 25% water, 1% baker's yeast (wt/wt);
3 = 25% water, 2% baker's yeast (wt/wt);
4 = 25% water, 0.5% baker's yeast (wt/wt), 750 ppm Zn;
5 = 25% water, 2% dry brewer's yeast (wt/wt);
6 = 20% water, 3% liquid molasses, 1% CaO (wt/wt), 750 ppm Zn; and
7 = 20% water, 3% crude glycerin, 3% liquid molasses.

The results showed that heating the moistened meal resulted in RUP formation but mixing of the moistened meal with combinations of processing aids elicited still further improvement in RUP formation. This was particularly notable for the addition of baker's yeast at the greater inclusion rate (2% wt/wt) and when water was substituted, in part, by crude glycerin and liquid molasses. Reducing the amount of water in the reaction is advantageous because less energy is then required to form a dry and stable composition having 10% moisture or less. A further advantage is substituting water with glycerol or molasses or both results in energy (caloric) enrichment of the composition, owing to the inherent energy of glycerol and molasses sugars. Also noted was improvement in RUP formation when molasses and calcium oxide (lime) were used. Elevating reaction pH to 10 or greater is advantageous for accelerating the Maillard reaction via effects on the amino groups of proteins while molasses provides reactive sugars that condense with the activated amino groups thus forming Maillard reaction products leading ultimately to RUP formation.

### Example 4

The process for producing RUP was tested in pilot-scale equipment capable of producing 400 lb per hour of a final composition. The method of manufacturing was as described previously except that a preheating step was tested in which a fluidized bed dryer was used to add moisture (water added at 5% vol/wt) and heat the proteins to approximately 200° F. before they were fed into the pug mill. Furthermore, two pug mills were used in sequence, to test potential benefits for longer retention time at this step. Finally, steam was added to at the pug mill step to test for potential benefits of exposing the composition to heat earlier in the processing. The rotation speed of the reacting-drying drum varied from 1.1 to 2.2 rpm to test for effects of agitation-contacting on efficacy of the process. Based upon operation of the equipment and visual appraisal of the compositions, selected aspects of design were eliminated or incorporated into the processing method described herein.

The proteins tested were mechanically extracted soybean meal, solvent-extracted soybean meal, cottonseed meal, and a 50:50 blend of cottonseed meal and soybean meal (wt/wt). In certain compositions, liquid lysine (50% lysine; Archer Daniels Midland Company) was added at 3% vol/wt. Dry granular processing aids were added to compositions according to the process in the following amounts (wt/wt): 3% dry molasses; 1.0% inactivated brewer's yeast; 0.214% ZnSO₄ (35% Zn ion) and 0.05% protease enzyme. The target Zn concentration in the final composition was 750 ppm. The process was operated over a series of days to produce ton quantities of material and samples were collected and analyzed for protein and RUP. The results are presented by Table 6.

The RUP content of mechanically extracted soybean meal was consistently improved over unprocessed meal, with a mean RUP content of 78% (% of CP) recorded for the processed meal, compared with a RUP content of 59% noted for untreated meal. Solvent extracted soybean meal had an initial RUP content of 38% of CP and processing increased RUP of the meal to 69%. The addition of 3% liquid lysine did not contribute to or diminish the RUP formation, but advantageously the lysine content of the composition was improved by approximately 1.5%. Cottonseed meal RUP percentage increased by nearly 20 percentage units with processing (43% versus 61%) at longer retention time (1.1 rpm) in the drum, whereas a shorter retention time was not as effective (49% RUP). Mixing and processing a blend of cottonseed meal and soybean meal resulted in improvements in RUP content for the composition compared to a calculated weighted average of the unprocessed blend. For the unprocessed mixture, the estimated RUP % was 40% whereas the mean for the processed mixture was 50%, representing a 25% increase in RUP content. Further, the addition of lysine is advantageous for increasing the lysine content of the final composition.

TABLE 6

| | Dry | Protein, | RUP, |
|---|---|---|---|
| Description | Matter, % | % of DM | % CP |
| Mechanically extracted soybean meal, | 93.6 | 49.6 | 59.3 |
| no treatment | | | |
| Processed meal day 1 | 89.5 | 53.1 | 77.8 |
| Processed meal day 2 sample 1 | 96.6 | 48.4 | 78.5 |
| Processed meal day 2 sample 2 | 93.7 | 48.7 | 77.1 |
| Solvent extracted soybean meal (SBM), | 88.0 | 55.6 | 37.8 |
| no treatment | | | |
| Processed meal | 91.2 | 56.4 | 68.9 |
| Processed meal + 3% liquid lysine | 92.9 | 55.1 | 67.3 |
| Cottonseed Meal Control (CSM), no | 88.4 | 59.0 | 42.5 |
| treatment | | | |
| Processed meal 1.1 rpm drum speed | 93.6 | 52.8 | 61.4 |
| Processed meal 2.2 rpm drum speed | 85.3 | 57.2 | 49.4 |
| Processed .50 CSM:.50 SBM blend + 3% | 90.2 | 53.9 | 51.2 |
| liquid lysine sample 1 | | | |
| Processed .50 CSM:.50 SBM blend + 3% | 91.7 | 56.1 | 46.5 |
| liquid lysine sample 2 | | | |
| Processed .50 CSM:.50 SBM blend + 3% | 94.9 | 53.4 | 50.9 |
| liquid lysine sample 3 | | | |

### Example 5

The processing method described herein was operated at pilot scale to assess effects on RUP and rumen undegradable amino acid content of compositions. This test evaluated the effects of retention time in the reacting-drying step of the process on characteristics of the final composition. The proteins used in this test included mechanically extracted soybean meal and a specific composition comprised of mechanically extracted soybean meal and canola meal. A dry granular blend of processing aids (Activation Blend 1) incorporated into the protein composition comprised molasses (3% wt/wt), inactivated dry brewer's yeast (1% wt/wt), protease enzyme (0.05% wt/wt) and 0.214% ZnSO₄ (35% Zn). A second dry granular blend of processing aids (Activation Blend 2) comprising reactive calcium oxide (1% wt/wt) and ZnSO₄ (0.214%; 35% Zn) was tested in the composition containing the mixture of proteins. A further evaluation in the processing of the protein mixture was that crude glycerin (3% vol/wt) partially substituted water in one part of the test, such that water addition to the process was reduced from 25% to 20% vol/wt. Liquid lysine (1.5% vol/wt; 50% lysine) was also tested in the protein mixture.

The characteristics of the proteins before and after processing are shown in Table 7. Notably, there was about an eight-percentage unit increase in RUP content observed for 20 minutes of processing time, with a smaller percentage increase noted when material was processed for an additional 20 minutes (40 minutes total). The mixture of mechanically extracted soybean meal and canola meal was responsive to processing, with a substantial increase of nearly 20 percentage points noted when the composition was processed with activation blend 1 for 20 minutes (54% versus 73.4% RUP for control versus processed). Activation blend 2 also elicited favorable effects on RUP, increasing the RUP to 73.2%. Activation blend 2 may advantageously exhibit superior shelf life and easier handling over activation blend 1, owning to activation blend 2 being comprised of inorganic minerals whereas blend 1 is comprised of biological materials sensitive to moisture and heat during storage. The test demonstrated that crude glycerin could partly substitute water and maintain a favorable RUP content in the final composition. The advantages of this substitution have been discussed previously. The composition containing liquid lysine exhibited a favorable RUP content over the unprocessed meals, and the addition of lysine is advantageous, as discussed earlier.

TABLE 7

| Description | Dry Matter, % | CP, DMB % | RUP, % CP |
|---|---|---|---|
| Mechanically extracted soybean meal, no treatment | 93.3 | 49.1 | 65.6 |
| Canola meal, no treatment | 89.3 | 46.0 | 31.6 |
| Mechanically extracted soybean meal:canola meal | 88.0 | 46.0 | 54.0 |
| no treatment (estimated composition) | | | |
| Mechanically extracted soybean meal, | 95.2 | 47.5 | 73.6 |
| Activation blend 1, 20-minute retention | | | |
| Mechanically extracted soybean meal, | 95.8 | 47.2 | 77.3 |
| Activation blend 1, 40-minutes retention | | | |
| Mechanically extracted soybean meal:canola meal | 96.1 | 44.5 | 73.4 |
| Activation blend 1, 20-minute retention | | | |
| Mechanically extracted soybean meal:canola meal | 95.8 | 44.7 | 68.4 |
| Activation blend 1, 40-minute retention | | | |
| Mechanically extracted soybean meal:canola meal | 96.6 | 44.2 | 69.9 |
| Activation blend 1, 3% glycerin, 40-minute | | | |
| retention | | | |
| Mechanically extracted soybean meal:canola meal | 95.9 | 45.6 | 73.2 |
| Activation blend 2, 40-minute retention | | | |
| Mechanically extracted soybean meal:canola meal | 96.4 | 45.2 | 67.0 |
| Activation blend 1, 1.5% liquid lysine, 40-minute | | | |
| retention | | | |

The effects of processing on the REAA and REAAi of mechanically extracted soybean meal and the mixture of mechanically extracted soybean meal:canola meal are presented in table 8, below. For these calculations, a RUP content of 77% was used for processed mechanically extracted soybean meal and a RUP content of 73% was used for the protein mixture. The measured amino acid content of the proteins was used in the calculations. Processing mechanically extracted soybean meal increased REAA by 30 grams per kg of dry weight whereas processing the protein mixture increased REAA by 39 grams per kg of dry weight. Notably, the specific REAA for essential amino acids considered most limiting to growth and milk protein synthesis (methionine, lysine, histidine, arginine) all improved with processing.

The REAAi of unprocessed and processed proteins was calculated relative to the profile of milk protein. Processing consistently improved the individual essential REAAi and the overall mean REAAi. In particular, processing improved the mean REAAi for (Met+Lys+His), the three amino acids that are considered most limiting for milk protein synthesis.

TABLE 8

| REAA, g/kg of | | | | | | | | | | | |
|---|---|---|---|---|---|---|---|---|---|---|---|
| dry weight | Met | Lys | Arg | Thr | Leu | Ile | Val | His | Phe | Trp | Sum |
| Mechanically | 1.41 | 6.22 | 8.28 | 4.50 | 8.87 | 4.63 | 5.30 | 2.54 | 4.78 | 1.48 | |
| extracted SBM AA, | | | | | | | | | | | |
| % of protein | | | | | | | | | | | |
| 65% RUP | 4.8 | 21.0 | 28.0 | 15.2 | 30.0 | 15.6 | 17.9 | 8.6 | 16.2 | 5.0 | 162 |
| (unprocessed) | | | | | | | | | | | |
| 77% RUP | 5.6 | 24.9 | 33.2 | 18.0 | 35.5 | 18.5 | 21.2 | 10.2 | 19.1 | 5.9 | 192 |
| (processed) | | | | | | | | | | | |
| Protein mixture AA, | 1.43 | 5.72 | 7.22 | 4.24 | 7.80 | 4.22 | 4.87 | 2.43 | 4.28 | 1.63 | |
| % of protein | | | | | | | | | | | |
| 54% RUP | 3.6 | 14.5 | 18.3 | 10.8 | 19.8 | 10.7 | 12.4 | 6.2 | 10.9 | 4.1 | 111 |
| (unprocessed) | | | | | | | | | | | |
| 73% RUP | 4.9 | 19.6 | 24.8 | 14.5 | 26.8 | 14.5 | 16.7 | 8.3 | 14.7 | 5.6 | 150 |
| (processed) | | | | | | | | | | | |

| | | | | | | | | | | | | Met + Lys + | |
|---|---|---|---|---|---|---|---|---|---|---|---|---|---|
| Milk protein | | | | | | | | | | | | His + Thr + | Met + Lys + |
| REAAi, % | Met | Lys | Arg | Thr | Leu | Ile | Val | His | Phe | Trp | EAAi | Ile | His |
| Mechanically | | | | | | | | | | | | | |
| extracted SBM | | | | | | | | | | | | | |
| 65% RUP | 34 | 53 | 158 | 79 | 63 | 52 | 58 | 60 | 46 | 64 | 67 | 52 | 49 |
| 77% RUP | 40 | 63 | 188 | 93 | 74 | 62 | 69 | 71 | 54 | 75 | 79 | 62 | 58 |
| Protein mixture | | | | | | | | | | | | | |
| 54% RUP | 28 | 41 | 115 | 62 | 46 | 39 | 45 | 48 | 34 | 58 | 52 | 40 | 39 |
| 73% RUP | 39 | 55 | 155 | 83 | 62 | 53 | 60 | 65 | 46 | 79 | 70 | 55 | 53 |

### Example 6

An embodiment of a disclosed processing method was operated at pilot scale to assess effects on RUP and rumen undegradable amino acid content of compositions. Mechanically extracted soybean meal and canola meal were mixed (0.68:0.28 wt:wt) and processed at 800 to 1,200 lb/hour. Liquid cane molasses (3% wt/wt) was added and a mixture of inactivated dry brewer's yeast (1% wt/wt), protease enzyme (0.05% wt/wt) and 0.214% ZnSO₄ (35% Zn) was incorporated into the protein mixture. The method of processing resulted in production of approximately 18 tons of processed material. Samples were collected from the sacks of finished material and assayed according to methods described herein.

Table 9 below shows the RUP of the individual proteins and the mixture of proteins before processing and the measured RUP of the mixture after processing. The estimated REAA and the REAAi are also presented. The REAAi was calculated relative to the amino acid profile of milk protein. Processing improved the RUP of the mixture by 20% (56% versus 67%). The estimated REAA improved for all essential amino acids, with an overall improvement of 23 grams of essential amino acid per kg of protein dry weight. The REAAi for the protein mixture was improved by processing. Notably, mixing and processing canola meal resulted in a superior REAAi compared with the REAAi of canola meal prior to mixing and processing. This was particularly noted for methionine, lysine, and histidine, the three amino acids considered most limiting for milk protein synthesis.

TABLE 9

| CP, | RUP, | REAA, g/kg of | | | | | | | | | | | |
|---|---|---|---|---|---|---|---|---|---|---|---|---|---|
| % of | % of | protein dry | | | | | | | | | | | |
| DM | CP | weight | Met | Lys | Arg | Thr | Leu | Ile | Val | His | Phe | Trp | Sum |
| 49.3 | 64 | Mechanically | 4.9 | 18.7 | 20.9 | 12.7 | 24.6 | 14.7 | 15.4 | 9.4 | 16.4 | 4.1 | 141 |
| | | processed | | | | | | | | | | | |
| | | soybean meal, | | | | | | | | | | | |
| | | unprocessed | | | | | | | | | | | |
| 49.0 | 36 | Solvent extracted | 3.5 | 9.7 | 10.4 | 7.8 | 12.2 | 6.9 | 9.0 | 4.7 | 7.0 | 2.4 | 74 |
| | | canola meal | | | | | | | | | | | |
| | | unprocessed | | | | | | | | | | | |
| 47.0 | 56 | Protein mixture | 4.3 | 15.4 | 17.1 | 10.8 | 20.2 | 12.0 | 13.0 | 7.7 | 13.1 | 3.5 | 117 |
| | | unprocessed | | | | | | | | | | | |
| 47.0 | 67 | Protein mixture | 5.2 | 18.5 | 20.6 | 12.9 | 24.2 | 14.4 | 15.6 | 9.2 | 15.8 | 4.2 | 140 |
| | | processed | | | | | | | | | | | |

| | | | | | | | | | | | | Met + Lys + |
|---|---|---|---|---|---|---|---|---|---|---|---|---|
| REAAi | Met | Lys | Arg | Thr | Leu | Ile | Val | His | Phe | Trp | EAAi | His |
| Mechanically | 37 | 50 | 125 | 69 | 54 | 52 | 53 | 70 | 49 | 55 | 61 | 52 |
| processed | | | | | | | | | | | | |
| soybean meal | | | | | | | | | | | | |
| Solvent extracted | 26 | 26 | 63 | 43 | 27 | 24 | 31 | 35 | 21 | 32 | 33 | 29 |
| canola meal | | | | | | | | | | | | |
| Protein mixture | 32 | 41 | 102 | 59 | 45 | 42 | 45 | 57 | 39 | 47 | 51 | 43 |
| unprocessed | | | | | | | | | | | | |
| Protein mixture | 39 | 49 | 123 | 71 | 54 | 50 | 54 | 68 | 47 | 56 | 61 | 52 |
| processed | | | | | | | | | | | | |

### Example 7

An embodiment of a disclosed processing method was operated at pilot scale to assess effects on RUP and rumen undegradable amino acid content of compositions. Solvent extracted soybean meal was processed alone or in combination with canola meal (0.78.28 wt:wt) in an oil-heated indirect batch processing device. The unit was heated to varying temperatures and water was added to vary moisture amounts and a mixture of inactivated dry brewer's yeast (1% wt/wt), protease enzyme (0.05% wt/wt) and 0.214% ZnSO₄ (35% Zn) was incorporated into the protein mixture. For certain batches, liquid lysine (50% actual lysine), was added at 2% of the total composition. The method of processing resulted in production of approximately 0.20 tons of processed material per batch. After being batch-processed for varying times, the processed compositions were discharged into 55-gallon metal drums and steeped for 1, 2, or 24 hours. Samples were collected at discharge from the unit, and at the completion of the steeping time. The compositions were assayed according to methods described herein. The results are presented in the table. The method of processing increased the RUP content of soybean meal or the combination of soybean meal and canola meal. These effects were particularly observed when temperature of the processing vessel was increased, and when time in the batch processer was increased. A novel observation was the substantial benefits attributed to steeping the processed compositions after they were discharged from the batch processor.

The batch processor operated according to the embodiment achieved a high bypass protein content of soybean meal and blends of soybean meal and canola meal. For certain treatments, bypass protein content was >80% of CP and the digestibility of the bypass protein was not compromised by the processing. Samples that were assayed by in vitro methods had digestible bypass protein content of >80%, which is very high. The process was effectively operated with as little as 15% total moisture, which is beneficial for reducing the operating expenses associated with drying of the wetted meal. The process produced a 75-80% RUP product in 15 to 30 minutes of processing time, once the wetted meals are at target temperature of 210 F. Steeping of the processed materials for at least one hour resulted in substantial improvements in bypass content. For certain batches, 10 additional units of RUP were measured after 1 hour of steeping. The results of this trial demonstrated the benefits in RUP when material was steeped after being processed.

TABLE 10

| | | Total | | | | | | | | | |
|---|---|---|---|---|---|---|---|---|---|---|---|
| | | moisture | | | | | | | | | |
| | Oil | in | Pre-heat | | Steep | | | CP, | | Intestinal | |
| Sample | Jacket | process, | time, | Processing | time, | DM, | Moisture, | % of | RUP, | digestibility | Zn, |
| Description | tem, F | % | min | time, min | hr | % | % | DM | % CP | of RUP, % | ppm |
| 21-01 SBM | | | | | | 88.1 | 11.9 | 51.60 | 36.2 | | 51 |
| 21-01 CANOLA | | | | | | 89.4 | 10.6 | 44.00 | 39.2 | | 64 |
| MEAL | | | | | | | | | | | |
| AMINO PLUS 3 | | | | | | 87.4 | 12.6 | 49.90 | 71.8 | | 56 |
| 21-01 1 SBM | 350 | 20 | 15 | 45 | 0 | 93.2 | 6.8 | 51.50 | 70.7 | | 941 |
| 21-01 2 SBM | 350 | 20 | 15 | 45 | 1 | 93.9 | 6.1 | 52.10 | 78.7 | | 908 |
| 21-01 3 SBM | 350 | 20 | 15 | 45 | 2 | 94.0 | 6.0 | 51.60 | 79.4 | | 856 |
| 21-01 4 SBM | 350 | 20 | 15 | 45 | 24 | 94.1 | 5.9 | 51.60 | 82.8 | | 992 |
| 21-01 6 SBM | 400 | 20 | 13 | 30 | 0 | 95.7 | 4.3 | 50.70 | 78.3 | 86.6 | 797 |
| 21-01 7 SBM | 400 | 20 | 13 | 30 | 1 | 96.1 | 3.9 | 50.80 | 81.6 | | 883 |
| 21-01 8 SBM | 400 | 20 | 13 | 30 | 2 | 96.1 | 3.9 | 51.00 | 82.7 | 87.3 | 1065 |
| 21-01 9 SBM | 400 | 20 | 13 | 30 | 24 | 96.3 | 3.7 | 50.90 | 83.8 | | 1056 |
| 21-01 11 SBM | 450 | 20 | 11 | 15 | 0 | 93.1 | 6.9 | 50.90 | 56.0 | | 1048 |
| 21-01 12 SBM | 450 | 20 | 11 | 15 | 1 | 93.8 | 6.2 | 51.40 | 70.6 | | 1038 |
| 21-01 13 SBM | 450 | 20 | 11 | 15 | 2 | 94.0 | 6.0 | 51.40 | 76.3 | | 1061 |
| 21-01 18 SBM: | 450 | 20 | 15 | 26 | 0 | 95.2 | 4.8 | 49.80 | 65.7 | | 896 |
| CANOLA MEAL | | | | | | | | | | | |
| 21-01 19 SBM: | 450 | 20 | 13 | 26 | 1 | 95.5 | 4.5 | 49.70 | 73.1 | | 989 |
| CANOLA MEAL | | | | | | | | | | | |
| 21-01 20 SBM: | 450 | 20 | 13 | 26 | 2 | 95.5 | 4.5 | 49.90 | 78.8 | 84.8 | 950 |
| CANOLA MEAL | | | | | | | | | | | |
| 21-01 21 SBM: | 450 | 20 | 13 | 28 | 0 | 96.0 | 4.0 | 50.30 | 65.9 | | 909 |
| CANOLA MEAL + | | | | | | | | | | | |
| 2% Liq. Lys at | | | | | | | | | | | |
| end | | | | | | | | | | | |
| 21-01 22 SBM: | 450 | 20 | 13 | 28 | 1 | 96.2 | 3.8 | 50.30 | 72.8 | | 919 |
| CANOLA MEAL + | | | | | | | | | | | |
| 2% Liq. Lys at | | | | | | | | | | | |
| end | | | | | | | | | | | |
| 21-01 23 SBM: | 450 | 20 | 13 | 28 | 2 | 96.2 | 3.8 | 50.50 | 71.8 | 84.3 | 997 |
| CANOLA MEAL + | | | | | | | | | | | |
| 2% Liq. Lys at | | | | | | | | | | | |
| end | | | | | | | | | | | |
| 21-01 24 SBM | 450 | 18 | 12 | 21 | 0 | 94.8 | 5.2 | 51.20 | 65.6 | | 1051 |
| 21-01 25 SBM | 450 | 18 | 12 | 21 | 1 | 94.9 | 5.1 | 51.50 | 76.7 | | 920 |
| 21-01 26 SBM | 450 | 18 | 12 | 21 | 2 | 95.1 | 4.9 | 51.60 | 77.1 | | 785 |
| 21-01 27 SBM | 450 | 15 | 12 | 15 | 0 | 94.4 | 5.6 | 51.40 | 68.0 | | 1076 |
| 21-01 28 SBM | 450 | 15 | 12 | 15 | 1 | 95.0 | 5.0 | 51.50 | 79.7 | | 905 |
| 21-01 29 SBM | 450 | 15 | 12 | 15 | 2 | 94.8 | 5.2 | 51.60 | 76.7 | | 1032 |

We claim:

1. A method, comprising:
mixing selected protein sources to produce a protein mixture having an amino acid pattern that aligns with ruminant lean tissue, milk protein, or both;
adding processing aids to the protein mixture to facilitate non-enzymatic browning of proteins provided by the protein sources;
adding a solvent to the protein mixture to form a solvent protein mixture;
agitating the solvent protein mixture;
heating the solvent protein mixture;
drying the solvent protein mixture to form a dried protein mixture;
processing the dried protein mixture to produce a final dry mixture having a particle size of from 800 to 1200 microns.

2. The method according to claim 1 wherein the protein sources are selected from oil seeds, grains, pulses, legumes, animal proteins, grain processing coproducts, gluten feed, gluten meal.

3. The method according to claim 1 further comprising mixing a meal with the protein mixture to form a meal protein mixture, wherein the meal is from a prior process that has been heated to a meal temperature from 160° F. to 250° F.

4. The method according to claim 1 wherein:
(i) the processing aids are selected from yeast, reactive sugars, protease enzymes, metal ions, and combinations thereof; or
(ii) the solvent is added at 1 wt % to 15 wt %, and is selected from water, glycerin, crude glycerol, high fructose corn syrup, liquid whey, and combinations thereof; or
(iii) both (i) and (ii).

5. The method according to claim 1 wherein the processing aids are selected from:
from 0.5 wt % to 2 wt % of inactivated saccharomyces yeast to provide reactive sugars found in the yeast cell wall and cell soluble fraction;
0.5 wt % to 3 wt % of reducing sugar;
0.01 to 0.2 wt % of a protease enzyme;
500 to 1,000 ppm of a soluble metal; and
combinations thereof.

6. The method according to claim 5 wherein:
(i) the sugar in the yeast cell wall is galactose and the sugar in the cell soluble fraction is ribose; or
(ii) the reducing sugar is provided by cane molasses; or
(iii) the reducing sugar is selected from xylose, glucose, sucrose, glucose, or any combinations thereof; or
(iv) both (i) and (ii), or both (i) and (iii).

7. The method according to claim 5 comprising using 750 ppm of a soluble metal ion.

8. The method according to claim 7 wherein the metal ion is a divalent metal ion selected from Zn, Cu or Fe.

9. The method according to claim 1 wherein drying the solvent protein mixture comprises drying to provide a moisture content of from 2 wt % to 12 wt %.

10. The method according to claim 1 further comprising:
(i) adding additional liquids to the solvent protein mixture during the drying step, wherein the additional liquids are selected from amino acids, soluble proteins, fermentation cell masses, lipids, and combinations thereof; or
(ii) adding glycerin, liquid molasses, calcium oxide, or combinations thereof, to the initial protein mixture; or
(iii) tempering the final dry mixture; or
(iv) any combination of two or more of (i), (ii), and (iii).

11. The method according to claim 10 wherein the amino acids comprise lysine, methionine, or a combination thereof.

12. The method according to claim 1 wherein the initial protein sources are selected to form a protein mixture having complimentary rumen escape amino acid index (REAAi), and the method improves the rumen undegradable protein (RUP) % of the protein mixture.

13. The method according to claim 1 wherein:
the processing aids are baker's yeast, Zn²⁺, or a combination thereof; or
the processing aids comprise molasses (3% wt/wt), inactivated dry brewer's yeast (1% wt/wt), protease enzyme (0.05% wt/wt) and 0.2% ZnSO₄ (35% Zn); or
the processing aids comprise reactive calcium oxide (1% wt/wt) and ZnSO₄ (0.2% wt/wt; 35% Zn).

14. The method according to claim 1 wherein the RUP content of the dried protein mixture is increased by up to 25% compared to unprocessed mixtures.

15. The method according to claim 1 wherein the initial protein source comprises:
(i) mechanically extracted soybean meal, and the RUP of the soybean meal is increased by the process by about 20%;
(ii) solvent extracted soybean meal, and the RUP of the soybean meal is increased by the process by about 30%;
(iii) cottonseed meal, and the RUP of the cottonseed meal is increased by the process by about 18%; or
(iv) any combination of two or more of (i), (ii), and (iii).

16. The method according to claim 15, wherein the initial protein source comprises:
mechanically extracted soybean meal, and the RUP of the soybean meal is increased by 59% to about 78%;
solvent extracted soybean meal, and the RUP of the soybean meal is increased from about 38% to about 69%; or
cottonseed meal, and the RUP of the cottonseed meal is increased from 43% to 61%.

17. The method according to claim 1 further comprising adding lysine.

18. The method according to claim, 1 wherein:
the protein source comprises soybean meal and canola oil; and
the processing aids are selected from molasses (3% wt/wt), inactivated dry brewer's yeast (1% 25 wt/wt), protease enzyme (0.05% wt/wt) 0.2% ZnSO₄ (35% Zn), calcium oxide (1% wt/wt), and combinations thereof.

19. The method according to claim 18 wherein the RUP of mechanically extracted soybean meal improved by 20% with processing.

20. The method according to claim 1 wherein:
(i) processing the protein mixture increased REAA by 39 grams per kg of dry weight; or
(ii) processing improved the mean REAAi for (Met+Lys+His), the three amino acids that are considered most limiting for milk protein synthesis; or
(iii) both (i) and (ii).

21. The method according to claim 1 wherein heating the mixture comprises increasing a mixture temperature to 160° F. to 250° F.

22. A method, comprising:
mixing selected protein sources to form a protein mixture having an amino acid pattern that aligns with ruminant lean tissue, milk protein, or both, wherein the protein sources are selected from oil seeds, grains, pulses, legumes, animal proteins, grain processing coproducts, gluten feed, gluten meal, and combinations thereof;
adding processing aids to the protein mixture, wherein the processing aids are selected from 0.5 wt % to 2 wt % of inactivated saccharomyces yeast to provide reactive sugars found in the yeast cell wall and cell soluble fraction; 0.5 wt % to 3 wt % of reducing sugars selected from xylose, glucose, sucrose, glucose, or combinations thereof; 0.01 to 0.2 wt % of a protease enzyme; 500 to 1,000 ppm of a divalent metal ion selected from Zn, Cu or Fe; or combinations thereof;
adding a solvent to the protein mixture to form a solvent protein mixture, wherein the solvent is added at 1 wt % to 15 wt %, and is selected from water, glycerin, crude glycerol, high fructose corn syrup, liquid whey, and combinations thereof;
agitating the solvent protein mixture and increasing mixture temperature to 160° F. to 250° F.;
drying the solvent protein mixture to form a dried protein mixture having a moisture content of from 6 wt % to 8 wt %;
processing the dried protein mixture to produce a final feed mixture having a particle size of from 800 to 1200 microns; and
tempering the final feed mixture.

23. The method according to claim 22 wherein:
(i) the protein sources comprise soybean meal, canola meal, cottonseed meal, and combinations thereof; or
(ii) the divalent metal ion is Zn provided by ZnSO₄; or
(iii) both (i) and (ii).
